(19) United States
(12) Patent Application Publication
(10) Pub. No.: US 2017/0026785 A1
(43) Pub. Date: Jan. 26, 2017

(54) ITEM MANAGING SERVER, ITEM MANAGING METHOD, AND ITEM MANAGING NON-TRANSITORY COMPUTER READABLE MEDIA

(71) Applicant: LINE Corporation, Tokyo (JP)

(72) Inventor: KI TAEK JEONG, Seongnam-si (KR)

(73) Assignee: LINE Corporation, Tokyo (JP)

(21) Appl. No.: 15/188,201

(22) Filed: Jun. 21, 2016

(30) Foreign Application Priority Data
Jul. 22, 2015 (KR) 10-2015-0103779

(51) Int. Cl. H04W 4/02; G06F 3/0482; G06F 17/30

(52) U.S. Cl. CPC H04W 4/02; G06F 17/3053; G06F 3/0482

(57) ABSTRACT

An item managing method includes receiving an event sensed by a terminal of a first user, determining whether the received event meets an item acquisition condition, when it is determined that the received event meets the item acquisition condition, determining an item corresponding to the received event, adding a slot corresponding to the item to one or more owned groups of the first user, extracting one or more second users connected to the first user in a certain relationship, acquiring one or more owned groups of the one or more second users, and setting the one or more owned groups of the one or more second users as a shared group of the first user, and determining a collected group of the first user by taking into consideration the one or more owned groups of the first user and the shared group of the first user.

### CROSS-REFERENCE TO RELATED APPLICATION

This application claims the benefit of Korean Patent Application No. 10-2015-0103779, filed on Jul. 22, 2015, in the Korean Intellectual Property Office (KIPO), the disclosure of which is incorporated herein in its entirety by reference.

### BACKGROUND

1. Field

One or more example embodiments relate to an item managing server, an item managing method, and/or an item managing non-transitory computer readable media, and more particularly, to an item managing server, an item managing method, and an item managing non-transitory computer readable media, in which a collected group of the first user is determined by taking into consideration one or more owned groups of one or more second users connected to the first user in a certain relationship.

2. Description of the Related Art

With advances in communication networks, various online gaming services have been provided. In addition, due to performance improvements in graphic technologies and gaming user terminals (e.g., gaming consoles and/or computing devices capable of executing games), high-end game programs have been developed, and game contents precisely depicting a real world or a virtual world have been provided.

Therefore, online game use by users has increased, and game genres have also diversified. Among the latest games, sports games, role playing games, first-person shooter games, and the like have been in the spotlight as popular games.

Online games are characterized in that users simultaneously access the same game content system and enjoy the online game together. Users are able to enjoy a game through cooperation and/or competition between one another by manipulating characters respectively representing the users on the same game screen.

### SUMMARY

One or more example embodiments include an item managing server, an item managing method, and a non-transitory computer readable medium, in which a collected group of a first user is determined by taking into consideration owned groups of one or more second users connected to the first user in a certain relationship.

Additional aspects will be set forth in part in the description which follows and, in part, will be apparent from the description, or may be learned by practice of the presented example embodiments.

According to one or more example embodiments, a non-transitory computer-readable recording medium includes computer readable instructions, which when executed by at least one processor, cause the at least one processor to receive an event sensed by a terminal of a first user, determine whether the received event meets a desired item acquisition condition, when the received event is determined to meet the desired item acquisition condition, determine an item corresponding to the received event, add a slot corresponding to the item to one or more owned groups of the first user, extract one or more second users connected to the first user in a desired relationship, acquire one or more owned groups of the one or more second users, and set the one or more owned groups of the one or more second users as a shared group of the first user, and determine a collected group of the first user based on the one or more owned groups of the first user and the shared group of the first user.

The event may be generated when a difference between a location of the terminal of the first user and a first target location is within a desired distance, and the item corresponding to the event may be determined based on the location of the terminal of the first user and the first target location.

The event may be generated by a user input on a screen displayed via a display device of the terminal of the first user, and the item corresponding to the event may be determined according to image data acquired by the user input.

The event may be generated by a purchase action performed via the terminal of the first user, and the item corresponding to the event may be determined by an article purchased through the purchase action.

The processor may be further configured to determine a contribution of the first user based on the number of slots in collected groups of the one or more second users and determine a ranking of the first user based on the contribution of the first user, the number of slots being increased due to the one or more owned groups of the first user.

When the first user acquires all of the plurality of items respectively corresponding to the plurality of slots in one package, the processor may be further configured to provide a reward to the terminal of the first user.

In order to share information about an unowned group which does not belong to the collected group of the first user, the processor may be further configured to transmit the information about the unowned group of the first user to terminals of the one or more second users.

The setting of the shared group may include: acquiring one or more owned groups of a third user connected to the first user in a first relationship; and setting the one or more owned groups of the third user as the shared group of the first user, and the determining of the collected group may include determining the collected group of the first user based on the one or more owned groups of the first user and the one or more owned groups of the third user.

The processor may be further configured to evaluate a level of the first user based on at least two of the contribution, the one or more owned groups, the shared group, and the collected group of the first user.

According to one or more example embodiments, an item managing server configured to collect a plurality of items respectively corresponding to a plurality of slots in one package, includes: a memory having computer readable instructions stored thereon, at least one processor configured to execute the computer readable instructions to, receive an event sensed by a terminal of a first user, determine whether the event meets a desired item acquisition condition, when the received event is determined to meet the desired item acquisition condition, determine an item corresponding to the event, add a slot corresponding to the item to one or more owned groups of the first user, extract one or more second users connected to the first user in a desired relationship, acquire one or more owned groups of the one or more extracted second users, set the acquired one or more owned groups as a shared group of the first user, and determine a collected group of the first user based on the one or more owned groups of the first user and the shared group of the first user.

The at least one processor may further be configured to determine a contribution of the first user based on the number of slots in one or more collected groups of the one or more second users, and determine a ranking of the first user based on the contribution of the first user, and a number of slots being increased due to the one or more owned groups of the first user.

The at least one processor may further be configured to provide a reward to the terminal of the first user when the collected group of the first user collects all of the plurality of items respectively corresponding to the plurality of slots.

The at least one processor may further be configured to transmit the information about the unowned group of the first user to terminals of the one or more second users in order to share information about an unowned group which does not belong to the collected group of the first user.

The at least one processor may further be configured to acquire one or more owned groups of a third user connected to the first user in a first relationship, set the one or more owned groups of the third user as the shared group of the first user, and determine the collected group of the first user based on the one or more owned groups of the first user and the one or more owned groups of the third user.

The at least one processor may further be configured to calculate a level of the first user based on at least two of the contribution, the one or more owned groups, the shared group, and the collected group of the first user.

According to one or more example embodiments, a user terminal includes a memory having computer readable instructions stored thereon, and at least one processor configured to execute the computer readable instructions to collect an event using at least one sensor, transmit the collected event to an item managing server, receive at least one item corresponding to the event, the at least one item based on whether the collected event corresponds to at least one desired condition, and display a graphical user interface (GUI) indicating the received at least one item and a plurality of slots associated with the user terminal.

The at least one processor may be further configured to transmit a relationship request to at least one second terminal, the relationship request including at least one of a call, a videocall, an instant message, an SMS message, an email, and a social media message, receive a response to the transmitted relationship request, and transmit results of the relationship request response to the item managing server.

The user terminal may further include a plurality of sensors, the plurality of sensors including at least a location sensor, and the at least one processor may be further configured to obtain a current location of the user terminal using the location sensor, transmit the obtained current location of the user terminal to the item managing server, the item managing server configured to determine whether the obtained current location is within a desired distance from a desired target location, and receive an item based on results of the determining.

The plurality of sensors may further include a touch input sensor, and the at least one processor may be further configured to obtain a touch gesture using the touch input sensor, transmit the obtained touch gesture to the item managing server, the item managing server configured to determine whether the obtained touch gesture corresponds to a desired touch gesture, and receive an item based on results of the determining.

According to one or more example embodiments, a computer program is stored in a non-transitory computer readable medium to cause a computer to perform any one of the item managing methods.

According to one or more example embodiments, there are provided other methods and other systems for implementing the inventive concepts, and non-transitory computer-readable recording media having stored thereon a computer program for performing the methods.

Other aspects, features, advantages will become apparent from the accompanying drawing, claims, and detailed descriptions of one or more of the example embodiments.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram of an item managing system according to at least one example embodiment;

FIG. 2 is a block diagram of an item managing server according to at least one example embodiment;

FIG. 3 is a block diagram for describing a structure of a processor according to at least one example embodiment;

FIGS. 4 and 5 are flowcharts of an item managing method according to at least one example embodiment;

FIG. 6 is a block diagram of a user terminal according to at least one example embodiment;

FIG. 7 is a block diagram of a processor according to at least one example embodiment; and

FIGS. 8A to 8C and FIG. 9 are diagrams for describing a collected group of a user according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

According to at least one of the example embodiments, the term “slots” may be defined in connection with fictitious contents included in media data (e.g., animation, games, movies, etc.). Each of the slots may be defined as a real action in the real world (e.g., a roller coaster ride, rock climbing, round-the-world, etc.). Each of the slots may be a concept having a set offense power, a set level, a set turn, a set name, etc., and may be defined so as to correspond to a character, a city, an object, a level, or the like. In addition, each of the slots may be filled or collected according to a set condition. For example, the slots may be defined so as to correspond to jewels, weapons, clothes, stickers, or stamps, etc., which appear in a game application, an animation, or the like.

The term “package” used herein may be a collection of flags having a common attribute whose condition is true. The term “package” used herein may be a concept including a plurality of slots and may include a fixed number of slots. The package may be completely filled or collected through an event including all of a plurality of items matching a plurality of slots.

The term “items” may be objects matchable to a plurality of slots included in a package and may be connected to objects online or offline. In addition, the item may be acquired when it meets a condition of each of the slots or be acquired through an input such as a purchase, a transfer, an exchange, etc.

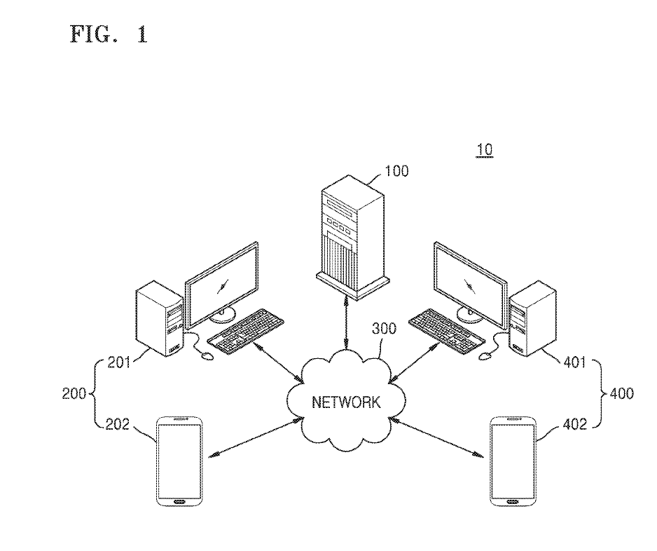

The plurality of slots included in the package may be filled or collected through an initially acquired item which meets the (optional) condition of each of the slots. FIG. 1 is a diagram of an item managing system 10 according to at least one example embodiment.

Referring to FIG. 1, the item managing system 10 according to at least one example embodiment may include an item managing server 100, user terminals 200 and 400, and a communication network 300.

The item managing server 100 may manage a plurality of slots included in one package, and one or more items, etc. The item managing server 100 may manage turns or names of the plurality of slots included in the package, etc. The item managing server 100 may function to store a plurality of slots included in a package generated by a first user, an acquisition condition of each of the slots, turns of the slots, and names of the slots, etc.

The item managing server 100 may allow a first item to be acquired based on an event, in-game, in real-life (e.g., reaching a desired geographical location, performing a desired physical motion/action, purchasing a desired product, etc.), and/or based on other desired event occurrences (e.g., relating to other software applications/environments/platforms, such as performing a desired communication action, a desired social media action, etc.), sensed by the user terminal 200. When an item meets a desired item acquisition condition (e.g., a desired in-game action, a desired real world action, etc.), the item may be acquired. The item acquisition condition may match a condition of each of the plurality of slots included in one package. The item managing server 100 may allow a second user to fill or collect a first slot through the acquired first item. The item managing server 100 may connect one or more registered users in a desired relationship. The relationship between the users may be generated through data transmission/reception between the users. The relationship between the users may be set through transmission/reception of a relationship request between the users, transmission/reception of an acceptance of the relationship request, transmission/reception of a message (e.g., email, SMS, instant message, social media message, etc.), transmission/reception of a call (e.g., telephone call, video call, etc.), etc. In the case of the transmission/reception of the relationship request, the relationship between the users may be set as a relationship designated by a user. In the case of the transmission/reception of the message and the transmission/reception of the call, the relationship between the users may be set by taking into consideration the number or a period of transmission/receptions of messages between the users and the number or a period of transmission/receptions of calls. For example, when the first user transmits a friendship request to the second user and receives an acceptance of the friendship request, a friendship may be set between the first user and the second user. When the number of the transmission/receptions of the messages between the first user and the second user is about 10 or more, a friendship may be set between the first user and the second user. While a relationship between two users is discussed, the example embodiments are not limited thereto and three or more users may be in a desired relationship according to various example embodiments.

A user may access the item managing server 100 through the user terminals 200 and 400. The user terminals 200 and 400 may receive information, a screen, or the like provided by the item managing server 100. The user terminals 200 and 400 may receive information about the plurality of slots included in one package. A plurality of user terminals 200 and 400 may mean a communication terminal through which a user is able to use a web service in a wired and/or wireless communication environment. The user terminal 200 may be a personal computer (PC) 201 or a portable terminal 202 of a user. The portable terminal 202 is illustrated in FIG. 1 as being a smartphone, but is not limited thereto. A terminal having installed therein an application for web browsing is applicable without limitation.

More specifically, examples of the user terminal 200 may include computers (e.g., a desktop computer, a laptop computer, a tablet computer, etc.), media computing platforms (e.g., a cable set-top box, a satellite set-top box, a digital video recorder, a media streaming device, etc.), handheld computing devices (e.g., a personal digital assistant (PDA), an email client, a smart device, a wearable device, etc.), a gaming console, an Internet of Things (loT) device, a virtual reality device, any type of mobile phones, and any other type of computing or communication platforms, but are not limited thereto.

The communication network 300 may connect the plurality of user terminals 200 and 400 to the item managing server 100. That is, the communication network 300 may mean a communication network that provides a connection path so that the user terminals 200 and 400 access the item managing server 100 and transmit and receive data. The communication network 300 may include wired networks, such as local area networks (LANs), metropolitan area networks (MANs), integrated service digital networks (ISDNs), fiber optic networks, cable networks, ethernet networks, etc., and wireless networks, such as wireless LANs, code division multiple access (CDMA) networks, Global System for Mobile Communications (GSM) networks, Bluetooth, radio-frequency communication networks, and satellite communication networks, but are not limited thereto.

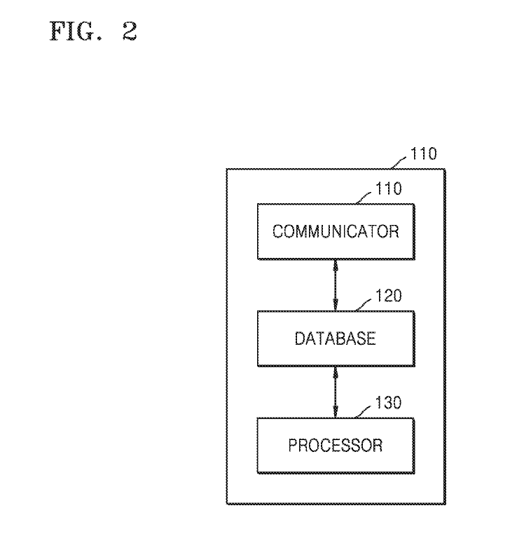

FIG. 2 is a block diagram of an item managing server 100 according to at least one example embodiment.

Referring to FIG. 2, the item managing server 100 according to at least one example embodiment may include a communicator 110, a database 120, and at least one processor 130.

The communicator 110 may include one or more elements enabling the item managing server 100 and one or more user terminals 200 and 400 to communicate with each other. For example, the communicator 110 may include a Bluetooth communicator, a Bluetooth low energy (BLE) communicator, a near field communicator (NFC), a wireless LAN (WLAN) (Wi-Fi) communicator, a ZigBee communicator, an infrared data association (IrDA) communicator, a Wi-Fi direct (WFD) communicator, an ultra wideband (UWB) communicator, and an Ant+communicator, etc., or may include a communicator that exchanges a wireless signal with at least one selected from a base station, an external terminal, and a server on a mobile communication network. However, the communicator 110 is not limited thereto. The wireless signal may include various types of data according to communication of a sound call signal, a moving picture call signal, or a text/multimedia message.

The database 120 may store information about one or more packages. The database 120 may store one or more items acquired by a user and store one or more slots collected through the one or more items. The database 120 is illustrated in FIG. 2 as being within the item managing server 100 for convenience of description, but may be in a non-transitory storage device outside the item managing server 100. The database 120 may include at least one selected from a flash memory, a hard disk, a solid state drive, a multimedia card micro-type memory, a card-type memory (e.g., SD or XD memory), random access memory (RAM), static random access memory (SRAM), read-only memory (ROM), electrically erasable programmable ROM (EEPROM), programmable read-only memory (PROM), a magnetic memory, a magnetic disk, an optical disk, etc. In addition, the item managing server 100 may operate a web storage, a distributed storage system, a network storage system, and/or a cloud server that performs a storage function of the database 120 over a computer network, such as the Internet, an intranet, a VPN, etc.

The processor 130 may control an overall operation of the item managing server 100. For example, the processor 130 may control the communicator 110, the database 120, and the like by executing programs stored in the database 120. The processor 130 may include any type of devices such as processors capable of processing data. The “processor” may mean a data processor embedded in hardware, which includes a circuit physically structured for performing functions represented by codes or commands included in a program. Examples of the data processor embedded in the hardware may include a microprocessor, a central processing unit (CPU), at least one processor core, a multiprocessor, an application-specific integrated circuit (ASIC), and a field programmable gate array (FPGA), etc., but are not limited thereto.

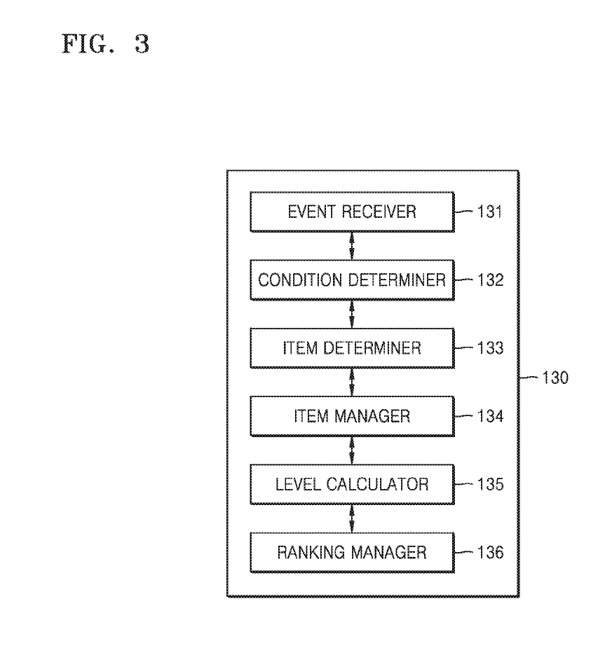

FIG. 3 is a block diagram for describing a structure of the processor 130. Referring to FIG. 3, the processor 130 may include an event receiver 131, a condition determiner 132, an item determiner 133, an item manager 134, a level calculator 135, and/or a ranking manager 136, but is not limited thereto.

The event receiver 131 may receive an event (e.g., in-game, in-real world, etc.) sensed though the user terminals 200 and 400 of one or more users registered in the item managing server 100. The users may be registered in the item managing server 100 through the user terminals 200 and 400 by using a link included in a membership registration and a message.

The condition determiner 132 may determine whether the sensed event meets an item acquisition condition. The item acquisition condition may be defined by an action or a motion of a user offline or online. The item acquisition condition may match a condition of each of a plurality of slots included in a package. The item acquisition condition may be set according to whether a difference between a location of the user terminals 200 and 400 and a set target location is within a certain critical and/or desired distance. The target location may be set as a place name, a tourist site, a facility, other real-world geographical location, other user terminal, or the like. For example, in a case where a first target location corresponding to a first slot included in one package is “Milano”, when a first location acquired through the user terminals 200 and 400 is placed within a critical and/or desired distance from “Milano”, i.e., the first target location corresponding to the first slot, the condition determiner 132 may determine that the event sensed by the user terminals 200 and 400 meets an item acquisition condition corresponding to the first slot. In addition, the target location may be set as an address corresponding to a preset location. For example, in a case where a second target location corresponding to a second slot included in one package is “Eonjuro 13, Dogok-dong, Seoul”, when a second location acquired through the user terminals 200 and 400 is placed within a critical and/or desired distance from “Eonjuro 13, Dogok-dong, Seoul”, i.e., the second target location corresponding to the second slot, the condition determiner 132 may determine that the event sensed by the user terminal 200 and 400 meets an item acquisition condition corresponding to the second slot.

According to some example embodiments, an item acquisition condition may be set according to whether a user input to a game application meets a condition set so as to correspond to each of slots. The item acquisition condition may be set according to whether an input is sensed by the user terminals 200 and 400 by executing a game application, the input being related to a level-up, a mission success, a win in a battle with other users or characters, and acquisition of objects (i.e., jewels, weapons, and clothes, etc.), or the like, in the game application. According to some example embodiments, an item acquisition condition may be set according to whether an article is purchased, the article corresponding to each of slots. That is, the item acquisition condition may be an input of purchasing an article corresponding to each of slots, or an input of purchasing an article corresponding to each of slots in an offline store, through the user terminals 200 and 400 by executing a shopping application. For example, when a first user purchases an article corresponding to a first slot in an offline store, and a code attached to the article corresponding to the first slot is recognized through the user terminals 200 and 400, the condition determiner 132 may determine that an input of sensing the code through the user terminals 200 and 400 meets the item acquisition condition corresponding to the first slot. When the first user purchases an article corresponding to a second slot by accessing a shopping application, the condition determiner 132 may determine that the purchase action meets the item acquisition condition corresponding to the second slot.

According to some example embodiments, an item acquisition condition may be set according to whether a user input matching a condition is sensed, the condition being set so as to correspond to each of the slots. For example, when certification photographing, or in other words desired image capturing, of a televised advertisement corresponding to a first slot is sensed by the user terminals 200 and 400, the condition determiner 132 may determine that the certification photographing meets the item acquisition condition corresponding to the first slot. For example, when an input of accessing a certain application is sensed at a certain and/or desired time corresponding to a second slot through the user terminals 200 and 400, the condition determiner 132 may determine that the input meets the item acquisition condition corresponding to the second slot.

In addition, the item acquisition condition may be set according to whether a user input meets an acquired character, an achieved level, or an attack degree, other game condition, etc., within a game application. Furthermore, the item acquisition condition may be set according to whether a location of the user terminals 200 and 400 approaches a desired and/or preset target location within a certain and/or desired target time randomly set. In addition, an item corresponding to a slot may be acquired through a game of chance, such as a dice game, roulette, card game, etc., and/or be acquired through an exchange or a transfer with other users. Furthermore, the item corresponding to the slot may be acquired when the number of accesses to a certain service proving server is more than a desired and/or preset critical number or when a user's level or offence degree exceeds a desired and/or preset critical level or critical attach degree. In addition, the item corresponding to the slot may be acquired through an action such as a personal information provision, a questionnaire response, social media activity, etc. performed by the user terminals 200 and 400.

According to some example embodiments, when a user input is sensed, the condition determiner 132 may determine that the user input meets an item acquisition condition, the user input being related to an action such as an item purchase, an item transfer, an item exchange, etc. When it is determined that the event meets the item acquisition condition, the item determiner 133 may determine a first item corresponding to the event. The item determiner 133 may determine an item acquired through a user event and a slot corresponding to the item.

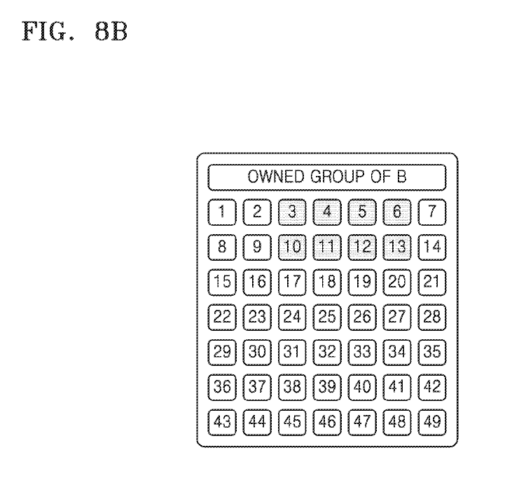

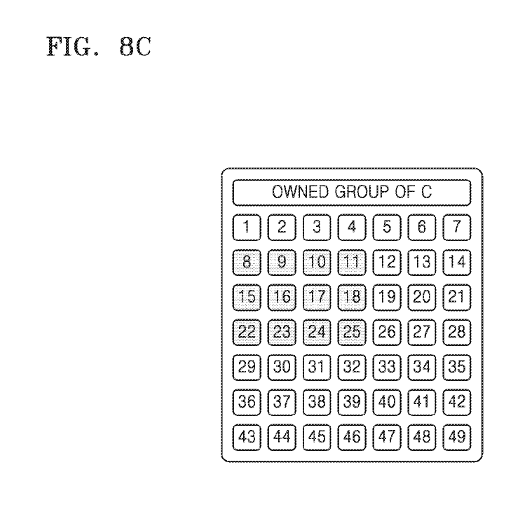

The item manager 134 may add a slot corresponding to the first item to owned groups of the first user. In addition, the item manager 134 may add one or more slots included in owned groups of users to a shared group of the first user, the users being connected to the first user in a desired and/or certain relationship. The item manager 134 may extract one or more second users connected to the first user in a desired and/or certain relationship and acquire owned groups of the one or more second users, which include one or more items owned by the one or more second users. The item manager 134 may add, to the shared group of the first user, one or more owned slots included in the owned groups of the one or more second users. Referring to FIGS. 8A to 8C (referred to collectively as FIG. 8), when A and B are connected to each other in a certain relationship, turns of slots included in a shared group of B may include turns (i.e., 1 to 3 and 8 to 10) of slots included in an owned group of A. When A and C are connected to each other in a desired and/or certain relationship, turns of slots included in a shared group of C may include the turns (i.e., 1 to 3 and 8 to 10) of slots included in the owned group of A. Turns of slots included in a shared group of A may include the turns (i.e., 3 to 6, 8 to 13, 15 to 18, 22, and 23) of slots included in the owned groups of B and C. The item manager 134 may determine the union of the owned groups and the shared group of the first user as the collected group of the first user. The collected group of the first user may include one or more slots included in the owned group of the first user and one or more slots included in the shared group of the first user. Referring to FIG. 8, turns of slots included in a collected group of B may be turns (i.e., 1 to 6 and 8 to 13) of slots included in the owned group and the shared group of B. Turns of slots included in a collected group of C may be the turns (i.e., 1 to 3, 8 to 11, 15 to 18, and 22 to 25) of slots included in the owned group and the shared group of C. Turns of slots included in the collected group of A may be the turns (i.e., 1 to 6, 8 to 13, 15 to 18, 22, and 22 to 25) of slots included in the owned group and the shared group of A.

The level calculator 135 may calculate a level of a user by taking into consideration at least two of slots included in an owned group, slots included in a shared group, and slots included in a collected group of the user. The level calculator 135 may calculate the level of the user based on a weighted average of proportions of the owned group, the shared group, and the collected group of the user to a plurality of slots included in total packages. In order to highly evaluate an importance of a desired and/or certain relationship online, the item managing server 100 according to some example embodiments may set a weighted value of an owned group so as to be less than a weighted value of a shared group and a weighted value of a collected value.

For example, as illustrated in FIG. 8, the level of A may be about 0.33 (=(1*3/49+2*18/49+3*20/49)/6) obtained by respectively adding weighted values of about 1, about 2, and about 3 to proportions of about 3/49, about 18/49, and about 20/49 respectively occupied by the owned group, the shared group, and the collected group of A, and taking the average of the weighted value-added results. The level of B may be about 0.19 obtained by respectively adding weighted values of about 1, about 2, and about 3 to proportions of about 8/49, about 6/49, and about 12/49 respectively occupied by the owned group, the shared group, and the collected group of B and taking the average of the weighted value-added results. The level of C may be about 0.23 obtained by respectively adding weighted values of about 1, about 2, and about 3 to proportions of about 12/49, about 6/49, and about 15/49 respectively occupied by the owned group, the shared group, and the collected group of C and taking the average of the weighted value-added results. As described above, according to at least one of the present example embodiments, although a user owns and/or is associated with many owned groups, when the user does not own many shared groups, a level of the user may be lowered. That is, the level of A including the least owned items may be set to the highest level.

According to some example embodiments, the level calculator 135 may calculate a level of a user based on the number of slots included in an inherent owned group of the user. The inherent owned group of the user may mean a group of the owned groups, which does not belong to a shared group and is classified into the owned group.

The level calculator 135 may determine a contribution of the first user based on the number of slots included in the collected groups of the one or more second users, the number of slots being increased due to the owned groups of the first user. The level calculator 135 may determine the level of the first user based on the contribution of the first user. Referring to FIG. 8, a contribution of A may be determined by adding the number of slots included in the collected groups of B and C, the number of slots being increased due to the owned group of A. That is, the contribution of A may be about 7 obtained by adding the number (e.g., about 4) of slots included in the collected group of B and the number (e.g., about 3) of slots included in the collected group of C, the number (e.g., about 4) of slots and the number (e.g., about 3) of slots being increased due to the owned group of A. A contribution of B may be about 6, that is, the number of slots included in the collected group of A, the number of the slots being increased due to the owned group of B. A contribution of C may be about 9, that is, the number of slots included in the collected group of A, the number of the slots being increased due to the owned group of C. That is, the level of C calculated based on the contribution may be calculated to be greater than the level of A and the level of B.

The ranking manager 136 may determine a ranking of a user based on at least one of a contribution, an owned group, a shared group, and a collected group of the user, etc. Referring to FIG. 8, when the ranking manager 136 determines a ranking based on the contribution, a ranking of a user may be determined in the order of C, A, and B. When the ranking manager 136 determines a ranking based on the number of slots included in the owned group, a ranking of a user may be determined in the order of C, B, and A. When the ranking manager 136 determines a ranking based on the number of slots included in the collected group, a ranking of a user may be determined in the order of A, C, and B. When the ranking manager 136 determines a ranking based on the number of slots included in the shared group, a ranking of a user may be determined in the order of A, B, and C. The item managing server 100 according to at least one example embodiment may further include a reward manager (not illustrated) configured to provide a certain reward to a terminal of the first user when the first user, for example, acquires all of the items corresponding to a plurality of slots included in one package. The reward manager may provide a reward calculated based on the number of one or more slots included in an owned group. According to some example embodiments, in order for the first user to share information about an unowned group which does not belong to the collected group of the first user, with one or more users connected to the first user in a certain relationship, the item manager 134 may transmit the information about the unowned group of the first user to terminals of the one or more users connected to the first user in the certain relationship.

In addition, the item manager 134 may add one or more slots to an inherent owned group of owned groups of a user, the one or more slots being not included in a shared group.

The level calculator 135 may calculate a level of a user by taking into consideration at least two of an owned group, a pure owned group, a shared group, and a collected group of a user. The ranking manager 136 may determine a ranking of a user based on a proportion occupied by the owned group, the pure owned group (e.g., solely owned group), the shared group, and the collected group of the user. Referring to FIG. 8, turns of slots included in a pure owned group of A having a relationship with B and C may be 1 and 2, turns of slots included in a pure owned group of B having a relationship with A may be 4 to 6 and 11 to 13, and turns of slots included in a pure owned group of C having a relationship with A may be 11, 15 to 18, and 22 to 25.

According to some example embodiments, when the item manager 134 sets a shared group, the item manager 134 may take into consideration an owned group of a user connected to the first user in a desired and/or certain first relationship. For example, the item managing server 100 may provide a friendship, a family relationship, a romantic relationship, and a colleagueship, and the family relationship, the romantic relationship, the friendship, and the colleagueship may be listed in a desired order of intimacy, e.g., a descending order, ascending order, random order, etc. For example, the item manager 134 may set a relationship more than the friendship as a first relationship and set owned groups of one or more users as the shared group of the first user, the one or more users being connected to the first user in the family relationship, the romantic relationship, and the friendship. In addition, the item managing server 100 may set, as the first relationship, a relationship exchanging a message more than once a week. The item managing server 100 may set, as the shared group of the first user, an owned group of a user exchanging a message with the first user more than once a week. Furthermore, the item managing server 100 may set, to the first relationship, a relationship exchanging a voice call more than once. The item managing server 100 may set, to the shared group of the first user, an owned group of a user exchanging a voice call with the first user more than once.

Therefore, the item managing server 100 according to at least one example embodiment may allow a user to collect an item by using an event of the user online or offline. In addition, the item managing server 100 may determine that one or more slots owned by the user and one or more slots owned by a user connected to the user in a relationship online or offline are collected.

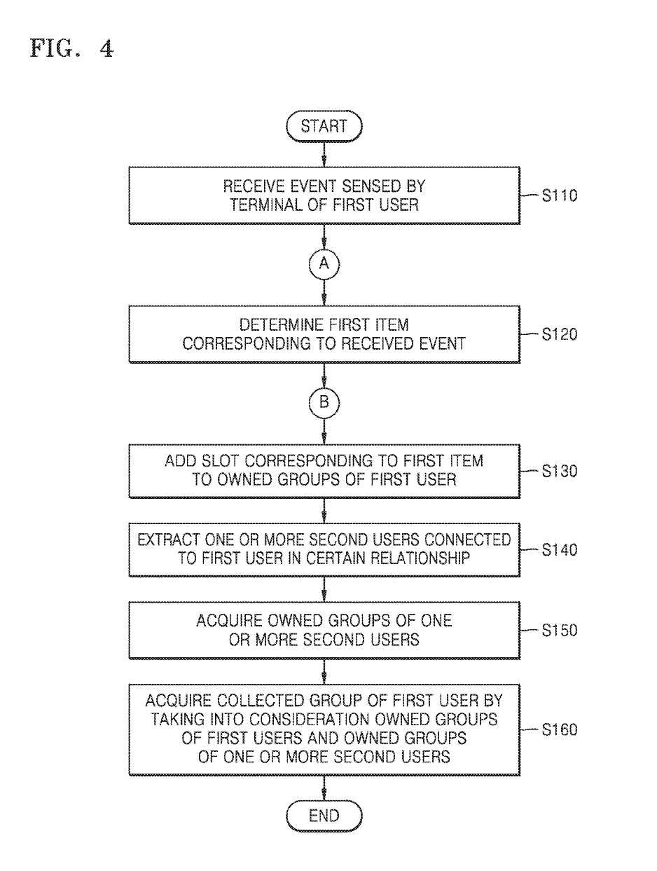

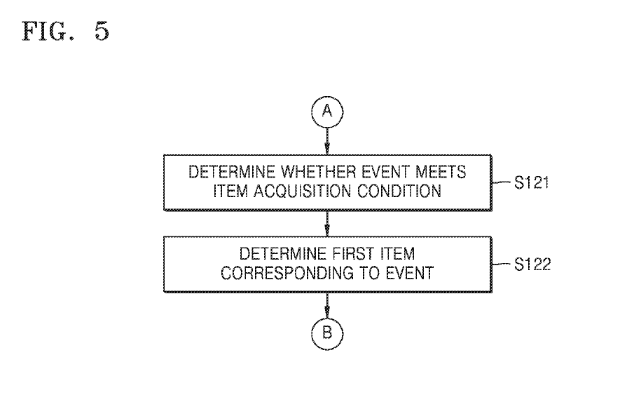

FIGS. 4 and 5 are flowcharts of an item managing method according to at least one example embodiment.

Referring to FIG. 4, the item managing method according to at least one example embodiment may include operation S110 of receiving an event, operation S120 of determining an item, operation S130 of determining owned groups, operation S140 of extracting one or more second users connected to a first user in a certain relationship, operation S150 of acquiring owned groups of the one or more second users, and operation S160 of acquiring a collected group of the first user.

In operation S110, an item managing server 100 may receive an event sensed though terminals of one or more users, which are registered in the item managing server 100.

In operation S120, the item managing server 100 may determine a first item corresponding to the event. As illustrated in FIG. 5, operation S120 may include operation S121 of determining whether the sensed event meets an item acquisition condition corresponding to a collection condition of each of a plurality of slots, and operation S122 of, when it is determined that the item meets the item acquisition condition, determining the first item corresponding to the event in the item managing server 100.

In operation S130, the item managing server 100 may add the first item and a slot corresponding to the first item to the owned groups of the first user. In operation S140, the item managing server 100 may extract the one or more second users connected to the first user in the desired and/or certain relationship. In operation S150, one or more owned groups of the one or more second users may be acquired, and the one or more owned groups of the one or more second users may be set as a shared group of the first user. In operation S160, the item managing server 100 may determine the collected group of the first user by taking into consideration the owned groups of the first user and the shared group of the first user. Since operation S160 is substantially the same as an operation of an item manager 134, detailed descriptions thereof will be omitted.

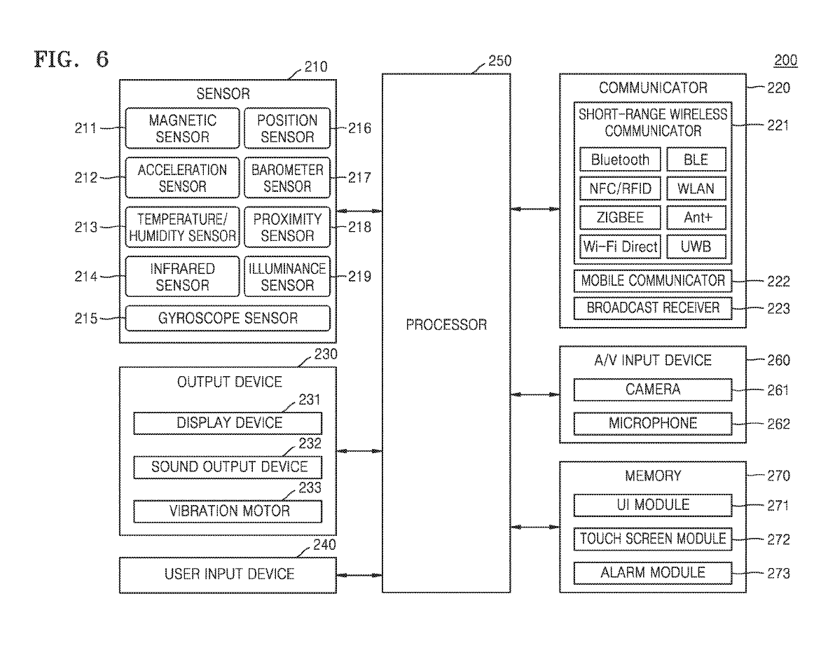

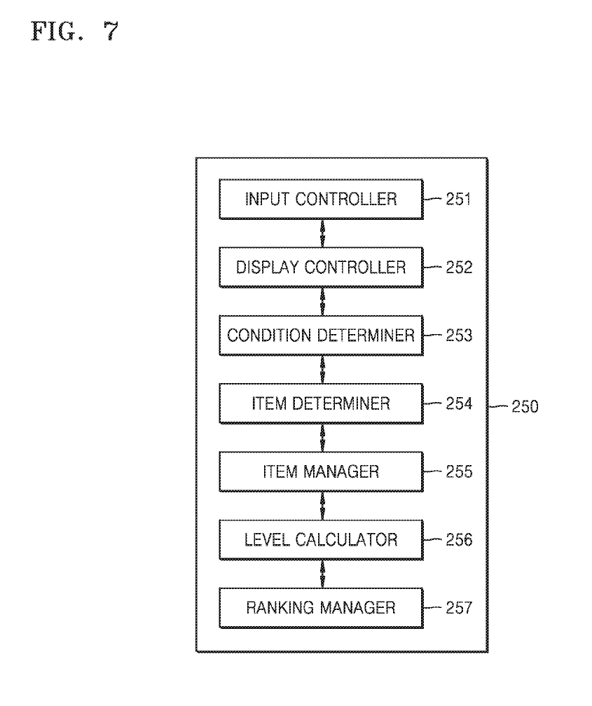

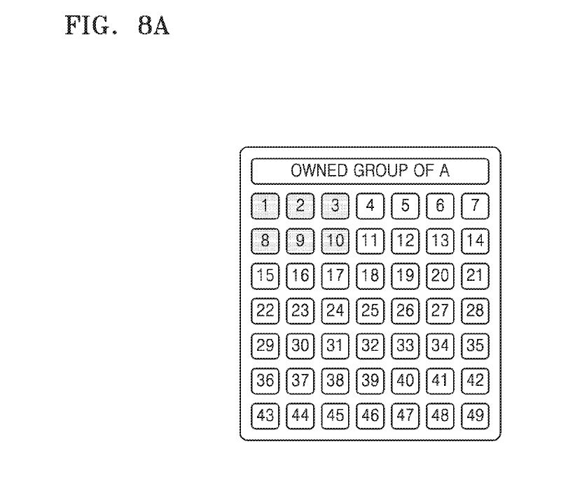

FIG. 6 is a block diagram of a user terminal 200 according to at least one example embodiment.

Referring to FIG. 6, the user terminal 200 according to the present example embodiment may include a sensor 210, a communicator 220, an output device 230, a user input device 240, at least one processor 250, an audio/video (A/V) input device 260, and a memory 270.

Hereinafter, the sensor 210, the communicator 220, the output device 230, the at least one processor 250, the user input device 240, the A/V input device 260, and the memory 270 will be described.

The sensor 210 may acquire location information of the user terminal 200. When the user terminal 200 moves, the sensor 210 may determine changed and/or current location information of the user terminal 200 by acquiring moving speed information and moving time information.

The sensor 210 may include at least one of a magnetic sensor 211, an acceleration sensor 212, a temperature/humidity sensor 213, an infrared sensor 214, a gyroscope sensor 215, a position sensor (for example, a GPS sensor, etc.) 216, a barometer sensor 217, a proximity sensor 218, and an RGB sensor (e.g., illuminance sensor and/or camera) 219, but is not limited thereto. Since a function of each of the sensors 211 to 219 is deducible from a name thereof by a person of ordinary skill in the art, detailed descriptions thereof will be omitted.

The sensor 210 may acquire state information of the user terminal 200. The sensor 210 may acquire information about at least one of a tilt of the user terminal 200, a direction in which the user terminal 200 is located, and a movement of the user terminal 200.

In addition, the sensor 210 may sense a user input. The sensor 210 may acquire information about at least one of a time length of the sensed user input and a type of the user input.

Furthermore, the sensor 210 may function to identify an identification code attached to an article. The identification code may be an RF code, a barcode, a QR code, an NFC code, or the like.

The communicator 220 may include one or more elements enabling a terminal, such as PC 201 (see FIG. 1), a portable terminal 202 (see FIG. 1), etc., of a user to communicate with each other, or the user terminal 200 and the item managing server 100 to communicate with each other. For example, the communicator 220 may include a short-range wireless communicator 221, a mobile communicator 222, and/or a broadcast receiver 223.

The short-range wireless communicator 221 may include a Bluetooth communicator, a Bluetooth low energy (BLE) communicator, a near field communicator (NFC), a WLAN (Wi-Fi) communicator, a ZigBee communicator, an infrared data association (IrDA) communicator, a Wi-Fi direct (WFD) communicator, an ultra wideband (UWB) communicator, and/or an Ant+ communicator, etc., but is not limited thereto.

The mobile communicator 222 may exchange a wireless signal with at least one of a base station, an external terminal, and a server on a mobile communication network. The wireless signal may include various types of data according to transmission/reception of a sound call signal, a moving picture call signal, a text/multimedia message, multimedia content, and/or other types of data.

The broadcast receiver 223 may receive a broadcast signal and/or information related to a broadcast from the outside through a broadcast channel. The broadcast channel may include a satellite channel and a ground wave channel. According to some example embodiments, the user terminal 200 may not include the broadcast receiver 223.

The output device 230 may include a display device 231, a sound output device 232, a vibration motor 233, and the like.

The display device 231 may display information processed by the user terminal 200. A user may watch a screen provided by the item managing server 100 through the display device 231.

A touch screen may be implemented by forming the display device 231 and a touch pad so as to have a mutual layer structure, allowing the display device to be used as both an output device and an input device. The display device 231 may include at least one of a liquid crystal display (LCD), a thin film transistor-liquid crystal display (TFT-LCD), an organic light-emitting diode (OLED), a flexible display, a three-dimensional display (3D display), and an electrophoretic display. According to a type of the user terminal 200, the user terminal 200 may include two or more display devices 231. At this time, the two or more display devices 231 may be arranged to face each other by using a hinge.

The sound output device 232 may output audio data that is received from the communicator 220 or is stored in the memory 270. In addition, the sound output device 232 may output a sound signal (e.g., a background sound output when an application is executed, and an effect sound generated whenever an operation is performed in an application) related to capabilities performed by the user terminal 200. The sound output device 232 may include a speaker, a buzzer, and the like.

The vibration motor 233 may output a vibration signal. For example, the vibration motor 233 may output a vibration signal in concert with an output of audio data (e.g., an effect sound generated whenever an operation is performed in an application) or image data (e.g., an image changed when an operation is performed in a game application). In addition, the vibration motor 233 may output a vibration signal when a touch is input to the touch screen.

The at least one processor 250 may generally control an overall operation of the user terminal 200. For example, the at least one processor 250 may entirely control the sensor 210, the communicator 220, the output device 230, the user input device 240, the A/V input device 260, the memory 270, and the like by executing programs including computer readable instructions stored in the memory 270, wherein the loading of the programs/computer readable instructions into the at least one processor 250 transforms the processor into a special purpose processor.

The user input device 240 may mean a device through which a user inputs data for controlling the user terminal 200. For example, the user input device 240 may include at least one of a key pad, a dome switch, a capacitive-type touch pad, a resistive-type touch pad, an infrared beam-type touch pad, a surface acoustic wave-type touch pad, an integral strain gauge-type touch pad, a piezo effect-type touch pad, any other type of touch pad, a jog wheel, and a jog switch, but is not limited thereto.

The A/V input device 260 may input an audio signal or a video signal and include a camera 261, a microphone 262, and the like. The camera 261 may acquire an image frame such as a still image or a moving picture via an image sensor during a moving picture call mode or an image-capturing mode. An image captured via the image sensor may be processed by the processor 250 or a separate image processor (not illustrated).

The image frame processed by the camera 261 may be stored in the memory 270 or be transmitted to the outside via the communicator 220. According to a type of the user terminal 200, the A/V input device 260 may include two or more cameras 261.

The microphone 262 may receive a sound signal from the outside and process the received sound signal to an electrical voice data signal. For example, the microphone 262 may receive a sound signal from an external device or a speaker. In order to remove noise that occurs while the sound signal is received from the outside, the microphone 262 may use various noise removing algorithms.

The memory 270 may store a program for processing and controlling the processor 250 or store a plurality of pieces of input/output data (e.g., a plurality of menus, a plurality of first hierarchy submenus respectively corresponding to the plurality of menus, a plurality of second hierarchy submenus respectively corresponding to the plurality of first hierarchy submenus, etc.).

The memory 270 may store (and/or alternatively prestore) meta data about an application. In addition, the memory 270 may store information about an acquired length and type of a user input. The memory 270 may also store state information of the user terminal 200.

The memory 270 may include at least one selected from a flash memory, a hard disk, a solid state disk, a multimedia card micro-type memory, a card-type memory (e.g., SD or XD memory), RAM, SRAM, ROM, EEPROM, PROM, a magnetic memory, a magnetic disk, an optical disk, etc. In addition, the user terminal 200 may operate a web storage, a distributed storage system, a network storage system, and/or a cloud server that performs a storage function of the memory 270 over a computer network, such as the Internet, an intranet, a VPN, etc.

The programs stored in the memory 270 may be classified into a plurality of modules according to functions thereof. For example, the programs stored in the memory 270 may be classified into a user interface (UI) module 271, a touch screen module 272, an alarm module 273, and the like.

The UI module 271 may provide a specialized UI or graphical user interface (GUI) in connection with the user terminal 200 for each application. The touch screen module 272 may detect a user's touch gesture on a touch screen and transmit information about the touch gesture to the processor 250. The touch screen module 272 according to at least one example embodiment may recognize and analyze a touch code. The touch screen module 272 may include separate hardware including a controller.

Various sensors may be arranged inside or near the touch screen so as to detect a touch or a proximate touch on the touch screen. An example of the sensor that detects the touch on the touch screen may include a tactile sensor. The tactile sensor may detect a contact of a specific object at or beyond a sensitivity of a person. The tactile sensor may detect a variety of information such as roughness of a contact surface, hardness of a contact object, a temperature of a contact point, or the like. An example of the sensor that detects the touch on the touch screen may include a proximity sensor. The proximity sensor may detect the presence or absence of an object approaching a certain detection surface or an object existing nearby, by using a force of an electro-magnetic field or an infrared ray, without any mechanical contact. Examples of the proximity sensor may include a transmission-type photoelectric sensor, a direct reflection-type photoelectric sensor, a mirror reflection-type photoelectric sensor, a high-frequency oscillation-type proximity sensor, a capacitive-type proximity sensor, a magnetic-type proximity sensor, and an infrared proximity sensor. The touch gesture of the user may include a tap gesture, a touch & hold gesture, a double tap gesture, a drag gesture, a panning gesture, a flick gesture, a drag & drop gesture, a swipe gesture, and the like.

The alarm module 273 may generate a signal for notifying the user of an occurrence of an event in the user terminal 200. The alarm module 273 may output an alarm signal in the form of a video signal through the display device 231, output the alarm signal in the form of an audio signal through the sound output device 232, and output the alarm signal in the form of a vibration signal through the vibration motor 233.

Referring to FIG. 7, the at least one processor 250 of the user terminal 200 may include an input controller 251, a display controller 252, a condition determiner 253, an item determiner 254, an item manager 255, a level calculator 256, and/or a ranking manager 257.

The input controller 251 may control a user input to be input or sensed by the sensor 210, the user input device 240, and the A/V input device 260 of the user terminal 200 of the first user. The input controller 251 may control a location of the user terminal 200 to be input through the sensor 210 or control an event to be input in an installed application through the user input device 240.

The display controller 252 may control data about an item to be displayed via the display device 231. The display controller 252 may control one or more items owned by the first user and one or more items owned by second users to be displayed, the second users being connected to the first user in a certain relationship. In addition, the display controller 252 may control a slot or an item to be displayed via the display device 231, the slot or the item being acquired through an event sensed by the input controller 251. The display controller 252 may control an item or a slot corresponding to the item to be displayed in a pop-up window, the item being acquired in a state in which a user does not know or recognize the acquisition of the item. The display controller 252 may control a vibration and an alarm to be concurrently output.

The condition determiner 253 may determine whether the event input through the input controller 251 meets an item acquisition condition. Since the item acquisition condition is substantially the same as the description provided with reference to the condition determiner 132, detailed descriptions thereof will be omitted.

When it is determined that the event meets the item acquisition condition, the item determiner 254 may determine a first item corresponding to the event.

The item manager 255 may add a slot corresponding to the first item to the owned groups of the first user. In addition, the item manager 255 may extract one or more second users connected to the first user in certain relationship, acquire one or more owned groups of the one or more second users, and set the owned groups of the one or more second users as a shared group of the first user. At this time, in order to acquire a shared group, the item manager 255 may transmit a signal for requesting the shared group to the item managing server 100. The item manager 255 may verify the shared group of the first user by receiving a response corresponding to the signal. The item manager 255 may determine a collected group of the first user by taking into consideration the owned groups of the first user and the collected group of the first user.

In addition, when the collected group of the first user includes all of items corresponding to a plurality of slots, the item manager 255 may allow the first user to receive a reward corresponding to each of all of the items. That is, when the first user acquires all of items corresponding to a plurality of slots included in one package, the item manager 255 may provide the reward to a terminal of the first user. The reward may be exchanged for an article, a service, an action performed, an accomplishment achieved, etc., and may include mileage, a point, a coupon, and the like, which are usable in a shopping application or a game application.

The level calculator 256 may calculate a level of the first user by taking into consideration at least two of the owned groups, the shared group, and the collected group of the first user. Since the level calculation is substantially the same as the description provided with reference to the level calculator 135, detailed descriptions thereof will be omitted.

In addition, the level calculator 256 may determine a contribution of the first user based on the number of slots included in the collected groups of the one or more second users, the number of slots being increased due to the owned groups of the first user. The level calculator 256 may determine a level of the first user based on the contribution of the first user.

The ranking manager 257 may determine a ranking of the first user based on a proportion occupied by the contribution, the owned group, the shared group, or the collected group of the first user. In order to determine the ranking of the first user, the ranking manager 257 may request at least one user terminal 200 of one or more second users for information about an owned group, the one or more second users being connected to the first user by a certain relationship. In addition, the ranking manager 257 may determine the ranking of the first user based on the number of slots included in an inherent owned group of the owned groups of first user, which does not belong to a shared group.

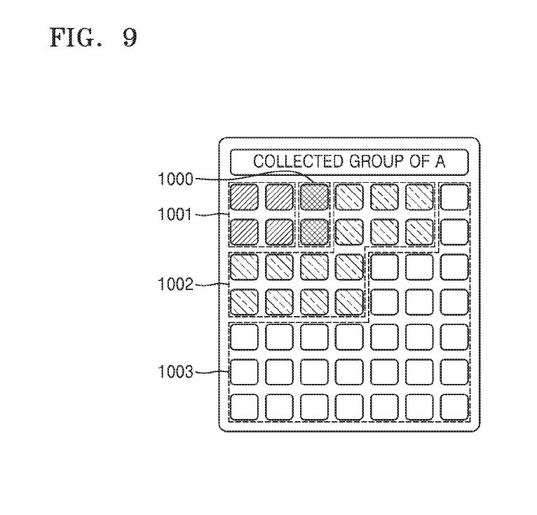

FIG. 9 is a block diagram for describing a collected group of a user.

As illustrated in FIG. 9, according to at least one example embodiment, a collected group of a first user may include owned groups 1000 and 1001 and owned groups 1002 and 1003 of a second user connected to the first user in a certain relationship. In particular, the owned group 1001 of the collected group of the first user, which is not owned by the second user, may be classified into an inherent owned group of the first user, and the owned group 1002 purely owned by the second user may be classified into a shared group of the first user. The remaining group 1003 except for the collected group of total packages may be classified into an unowned group of the first user.

According to at least one example embodiment, the collected group of the first user may be determined by taking into consideration owned groups of the one or more second users connected to the first user in a certain relationship.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A non-transitory computer-readable recording medium comprising computer readable instructions, which when executed by at least one processor, cause the at least one processor to:
receive an event sensed by a terminal of a first user;
determine whether the received event meets a desired item acquisition condition;
when the received event is determined to meet the desired item acquisition condition, determine an item corresponding to the received event;
add a slot corresponding to the item to one or more owned groups of the first user;
extract one or more second users connected to the first user in a desired relationship;
acquire one or more owned groups of the one or more second users, and set the one or more owned groups of the one or more second users as a shared group of the first user; and
determine a collected group of the first user based on the one or more owned groups of the first user and the shared group of the first user.

2. The non-transitory computer-readable recording medium of claim 1, wherein
the event is generated when a difference between a location of the terminal of the first user and a first target location is within a desired distance; and
the item corresponding to the event is determined based on the location of the terminal of the first user and the first target location.

3. The non-transitory computer-readable recording medium of claim 1, wherein
the event is generated by a user input on a screen displayed via a display device of the terminal of the first user; and
the item corresponding to the event is determined according to image data acquired by the user input.

4. The non-transitory computer-readable recording medium of claim 1, wherein
the event is generated by a purchase action performed via the terminal of the first user; and
the item corresponding to the event is determined by an article purchased through the purchase action.

5. The non-transitory computer-readable recording medium of claim 1, wherein the at least one processor is further caused to:
determine a contribution of the first user based on a number of slots in one or more collected groups of the one or more second users; and
determine a ranking of the first user based on the contribution of the first user, and the number of slots being increased due to the one or more owned groups of the first user.

6. The non-transitory computer-readable recording medium of claim 1, wherein the at least one processor is further caused to:
provide a reward to the terminal of the first user when the first user acquires all of the plurality of items respectively corresponding to the plurality of slots in one package.

7. The non-transitory computer-readable recording medium of claim 1, wherein the at least one processor is further caused to:
transmit the information about the unowned group of the first user to one or more terminals of the one or more second users in order to share information about an unowned group which does not belong to the collected group of the first user.

8. The non-transitory computer-readable recording medium of claim 1, wherein
the setting of the shared group comprises,
acquiring one or more owned groups of a third user connected to the first user in a first relationship;
setting the one or more owned groups of the third user as the shared group of the first user; and
the determining of the collected group comprises,
determining the collected group of the first user based on the one or more owned groups of the first user and the one or more owned groups of the third user.

9. The non-transitory computer-readable recording medium of claim 5, wherein the at least one processor is further caused to:
evaluate a level of the first user based on at least two of the contribution, the one or more owned groups, the shared group, and the collected group of the first user.

10. An item managing server configured to collect a plurality of items respectively corresponding to a plurality of slots in one package, the item managing server comprising:
a memory having computer readable instructions stored thereon; and
at least one processor configured to execute the computer readable instructions to:
receive an event sensed by a terminal of a first user;
determine whether the event meets a desired item acquisition condition;
when the received event is determined to meet the desired item acquisition condition, determine an item corresponding to the event;
add a slot corresponding to the item to one or more owned groups of the first user;
extract one or more second users connected to the first user in a desired relationship;
acquire one or more owned groups of the one or more extracted second users;
set the acquired one or more owned groups as a shared group of the first user; and
determine a collected group of the first user based on the one or more owned groups of the first user and the shared group of the first user.

11. The item managing server of claim 10, wherein
the event is generated when a difference between a location of the terminal of the first user and a first target location is within a desired distance; and
the item corresponding to the event is determined based on the location of the terminal of the first user and the first target location.

12. The item managing server of claim 10, wherein
the event is generated by a user input on a screen displayed via an output device of the terminal of the first user; and
the item corresponding to the event is determined according to image data acquired by the user input.

13. The item managing server of claim 10, wherein
the event is generated by a purchase action performed via the terminal of the first user; and
the item corresponding to the event is determined by an article purchased through the purchase action.

14. The item managing server of claim 10, wherein the at least one processor is further configured to:
determine a contribution of the first user based on the number of slots in one or more collected groups of the one or more second users; and
determine a ranking of the first user based on the contribution of the first user, and a number of slots being increased due to the one or more owned groups of the first user.

15. The item managing server of claim 10, wherein the at least one processor is further configured to:
provide a reward to the terminal of the first user when the collected group of the first user collects all of the plurality of items respectively corresponding to the plurality of slots.

16. The item managing server of claim 10, wherein the at least one processor is further configured to:
transmit the information about the unowned group of the first user to terminals of the one or more second users in order to share information about an unowned group which does not belong to the collected group of the first user.

17. The item managing server of claim 10, wherein the at least one processor is further configured to:
acquire one or more owned groups of a third user connected to the first user in a first relationship;
set the one or more owned groups of the third user as the shared group of the first user; and
determine the collected group of the first user based on the one or more owned groups of the first user and the one or more owned groups of the third user.

18. The item managing server of claim 14, wherein the at least one processor is further configured to:
calculate a level of the first user based on at least two of the contribution, the one or more owned groups, the shared group, and the collected group of the first user.
